(19) United States
(12) Patent Application Publication
(10) Pub. No.: US 2005/0242466 A1
(43) Pub. Date: Nov. 3, 2005

(54) Process for producing transparent material made of polylactic acid and transparent material made of polylactic acid

(76) Inventors: Shinichi Kanazawa, Osaka (JP); Kiyoshi Kawano, Osaka (JP); Fumio Yoshii, Gunma (JP); Toshiaki Yagi, Gunma (JP); Naotsugu Nagasawa, Gunma (JP)

Correspondence Address: MCDERMOTT WILL & EMERY LLP, 600 13TH STREET, N.W., WASHINGTON, DC, 20005-3096, US

(21) Appl. No.: 11/108,889

(22) Filed: Apr. 19, 2005

(30) Foreign Application Priority Data
Apr. 19, 2004 (JP) P.2004-123461

(51) Int. Cl. C08J 5/00; B29C 35/08

(52) U.S. Cl. 264/236; 264/331.21; 264/237; 264/488; 264/494

(57) ABSTRACT

The invention provides a process for producing a transparent polyactic acid material, comprising the steps of: kneading a polyactic acid with a monomer having two or more double bonds in its molecule; molding the kneaded product at a temperature of from the melting point of the polyactic acid to 200° C. to obtain a molded article; quenching the molded article after molding; and subjecting the quenched molded article to crosslinking treatment so as to prevent molecules of the polylactic acid from undergoing recrystallization. Also disclosed is a transparent polyactic acid material produced by the process.

### FIELD OF THE INVENTION

The present invention relates to a transparent material made of polylactic acid and to a process for producing the same. More precisely, in the fields where plastic products such as structural bodies and parts including films, containers and cases are utilized, the invention intends to maintain transparency, in an aged use state, of those utilized as biodegradable products or parts for solving waste disposal problems after use.

### BACKGROUND OF THE INVENTION

Currently, with regard to petroleum synthetic polymer materials utilized for a large number of films and containers, there arise various social problems, e.g., depletion of starting materials thereof and global warming caused by heat and exhaust gas generated from waste disposal by heating as well as influences of toxic substances in combustion gases and residues after combustion on foods and health and procurement of waste-burying sites.

For these problems, biodegradable polymers including starch and polylactic acid as representatives have hitherto attracted attention as materials solving such problems in waste disposal of petroleum synthetic polymers. As compared with the petroleum synthetic polymers, the biodegradable polymers exert no harmful effects on global environment including ecosystem since they exhaust low calories upon combustion and a cycle for degradation and re-synthesis thereof in natural environment is maintained. Of these polymers, aliphatic polyester-based polymers having properties comparative to the petroleum synthetic polymers in terms of strength and workability, are raw materials which have recently attracted attention. In particular, polylactic acid is produced from starch supplied from plants and becomes very inexpensive as compared with other biodegradable polymers owing to cost reduction by recent mass production, so that its applications are currently investigated extensively and biodegradable polymers containing polylactic acid as a main component have been provided in JP-A-2002-125905 (hereinafter referred to as “Patent Document 1”).

Since polylactic acid possesses workability and strength comparative to general-purpose petroleum synthetic polymers in view of properties thereof, it is the most promising biodegradable polymer as a substitute for the general-purpose petroleum synthetic polymers. Moreover, it is expected to have applications to various uses such as a substitute for acrylic resins due to transparency comparative to the resins and a substitute for ABS resin to be used for cases of electric equipments due to high Young's modulus and shape-retentive property. In particular, its transparency is the most characteristic feature that is not shown in other biodegradable resins.

The reason why the polylactic acid material can take on transparency is that light is transmitted without inhibition by crystals as shown in FIG. 1(A) in a non-crystalline state where the molecules of the polylactic acid are randomly present without crystallization. When the polylactic acid material is heated to a temperature equal to or higher than its glass transition temperature, non-crystalline molecules of the polylactic acid molecules begin to move and non-crystalline parts gradually change into crystals. As shown in FIG. 1(B), when a degree of crystallinity becomes high, light is reflected and the transparency is lost.

Since polylactic acid has a glass transition temperature of around 60° C. that is a relatively low temperature, when a surrounding temperature of a molded article formed from the polylactic acid material exceeds 60° C., transparency thereof cannot be maintained and the article becomes opaque.

60° C. is a temperature that air temperature or water temperature in nature does not easily reach but is a temperature reachable at the inside or window materials of an automobile whose windows are closed in the highest of summer, for example. When a transparent material gradually loses transparency by elevation of temperature due to light absorption, use conditions and applications thereof may be limited.

Even in the biodegradable material described in the above Patent Document 1, a gel fraction, which evaluates the degree of crosslinking, is from 58% to 86%, and thus molecules not crosslinked and freely movable remain in the polylactic acid molecules. Accordingly, at a temperature equal to or higher than 60° C., i.e., the glass transition temperature of polylactic acid, non-crystalline molecules move to crystallize, thereby causing a problem that transparency cannot be maintained.

### SUMMARY OF THE INVENTION

The invention is made in consideration of the above problems and an object thereof is to provide a biodegradable transparent material which possesses properties comparable to general-purpose petroleum synthetic polymers and has biodegradability suitable as a substitute therefor as well as which can maintain transparency.

Specifically, an object thereof is to provide a transparent material made of polylactic acid which improves a defect that transparency severely deteriorates at a temperature equal to or higher than the glass transition temperature.

Another object of the invention is to provide a process for producing the transparent material made of polylactic acid.

Other objects and effects of the present invention will become apparent from the following description.

The invention which has been accomplished for the purpose of solving the above problems is characterized by the constitution that almost the entire amount of polylactic acid molecules is crosslinked in a non-crystalline state so that non-crystalline molecules cannot freely move even when heated to a temperature equal to or higher than the glass transition temperature and thus crystallization thereof is prevented, whereby transparency can be maintained.

Specifically, in a first aspect, the invention provides a process for producing a transparent polylactic acid material, comprising the steps of:
kneading a polylactic acid with a monomer having two or more double bonds in its molecule;
molding the kneaded product at a temperature of from the melting point of the polylactic acid to 200° C.;
quenching the molded article after molding; and
subjecting the quenched molded article to crosslinking treatment so as to prevent molecules of the polylactic acid from undergoing recrystallization.

The above crosslinking treatment is conducted by irradiation with ionizing radiation or through preliminary incorporation of a chemical initiator into the kneaded product.

In a second aspect, the invention provides a transparent polylactic acid material obtained by the above-described process.

Alternatively, the invention provides a transparent polylactic acid material having a composition and properties similar to those of the material obtained by the above-described process.

The transparent polylactic acid material is formed from a mixture comprising a polylactic acid and a monomer having two or more double bonds in its molecule, wherein molecules of the polylactic acid are crosslinked and unified in a non-crystalline state where the polylactic acid molecules take a random arrangement, so that the molecules of the polylactic acid keep the non-crystalline state and are not recrystallized even when they are heated at a temperature equal to or higher than the glass transition temperature thereof.

### BRIEF DESCRIPTION OF THE DRAWINGS

FIG. 1(A) is a schematic view illustrating a non-crystalline state of polylactic acid molecules, which gives a transparent state. FIG. 1(B) is a schematic view illustrating a crystalline state of polylactic acid molecules, which gives an opaque state due to whitening.

FIG. 2 is a graph illustrating heat evolution and heat absorption of a material made of polylactic acid which is completely crosslinked (100% crosslinking) and a material made of polylactic acid without crosslinking, measured on a differential scanning calorimeter.

FIG. 3 is a graph illustrating relations between the exposure doses of electron beam and the gel fractions in Examples 1 to 3 and Comparative Examples 1 to 6.

FIG. 4 is a graph illustrating relations between wavelength and absorbance when the sample of Comparative Example 4 (with no electron beam irradiation) is placed under an atmosphere of 100° C. for 0 minute, 3 minutes, 10 minutes, 20 minutes, 40 minutes, and 80 minutes.

FIG. 5 is a graph illustrating relations between wavelength and absorbance when the sample of Comparative Example 5 (with an exposure dose of electron beam of 50 kGy) is placed under an atmosphere of 100° C. for 0 minute, 3 minutes, 10 minutes, 20 minutes, 40 minutes, and 80 minutes.

FIG. 6 is a graph illustrating relations between wavelength and absorbance when the sample of Example 1 (with an exposure dose of electron beam of 100 kGy) is placed under an atmosphere of 100° C. for 0 minute, 3 minutes, 10 minutes, 20 minutes, 40 minutes, and 80 minutes.

FIG. 7 is a graph illustrating relations between time and absorbance at a wavelength of 600 nm when the samples of Comparative Example 4 (with an exposure dose of electron beam of 0 to 50 kGy) are placed under an atmosphere of 100° C.

FIG. 8 is a graph illustrating relations between time and absorbance at a wavelength of 600 nm when the samples of Comparative Example 5 (with an exposure dose of electron beam of 0 to 150 kGy) are placed under an atmosphere of 100° C.

FIG. 9 is a graph illustrating relations between time and absorbance at a wavelength of 600 nm when the samples of Comparative Example 6 (with an exposure dose of electron beam of 0 to 200 kGy) are placed under an atmosphere of 100° C.

FIG. 10 is a graph illustrating relations between time and absorbance at a wavelength of 600 nm when the samples of Comparative Examples 1 and 2 and Examples 1 and 2 are placed under an atmosphere of 100° C.

FIG. 11 is a graph illustrating relations between time and absorbance at a wavelength of 600 nm when the samples of Comparative Example 3 and Example 3 of the invention are placed under an atmosphere of 100° C.

FIG. 12 is a graph illustrating heat absorption curves of the samples of Comparative Examples 4 and 5 and Example 1 on a differential scanning calorimeter.

FIG. 13 is a graph showing the effect of an annealing treatment on the absorbance characteristic.

### DETAILED DESCRIPTION OF THE INVENTION

In the transparent material made of polylactic acid according to the invention, the entire amount of the polylactic acid molecules is crosslinked in a non-crystalline state by irradiation with ionizing radiation or incorporation of a chemical initiator and thus are unified in a restrained state where the polylactic acid molecules cannot freely move, so as to attain a gel fraction of 100%.

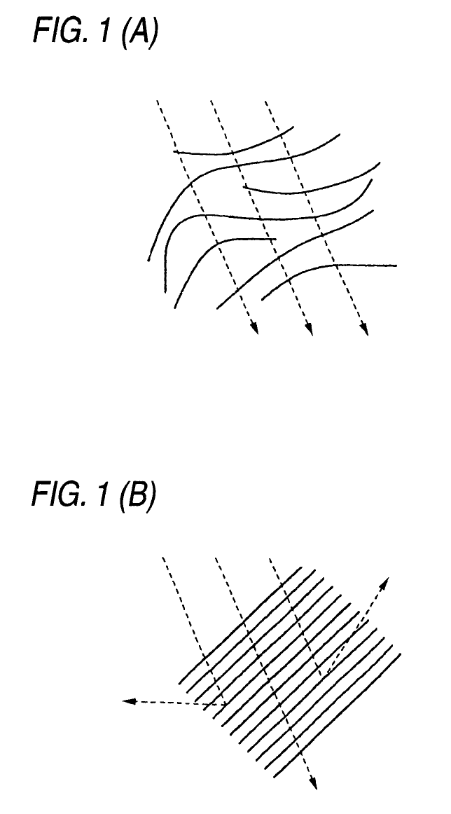

Thus, by crosslinking the entire amount of the polylactic acid molecules in a non-crystalline state, the polylactic acid molecules are restrained and cannot freely move even when heated to a temperature equal to or higher than the glass transition temperature of polylactic acid (about 60° C.). As a result, the molecules are not crystallized and a random arrangement of the polylactic acid molecules as shown in the aforementioned FIG. 1(A) is maintained, so that maintenance of transparency at a high temperature can be achieved.

In this connection, the “entire amount” in the phrase that the entire amount of the polylactic acid molecules is crosslinked or the “100%” in gel fraction has an admissible error upon measurement of +3%.

The above gel fraction means a ratio of unified molecules by radiation crosslinking and is a measure that evaluates the degree of crosslinking.

With regard to the gel fraction, a predetermined amount, for example, 0.5 g of a sheet crosslinked by irradiation with ionizing radiation is wrapped in a 200 mesh stainless woven wire and boiled in chloroform for 48 hours, and then remaining gel matter is obtained by removing sol matter dissolved in chloroform. Chloroform in the gel matter is removed by drying at 50° C. for 24 hours and the dry weight of the gel matter is measured, followed by calculation of the gel fraction according to the following equation.
Gel fraction (%)=(dry weight of gel matter)/(initial dry weight)×100

Moreover, the transparent material made of polylactic acid according to the invention exhibits no heat absorption due to crystal melting at a temperature equal to or higher than the melting point of the polylactic acid in the melting point heat absorption analysis by means of a differential scanning calorimeter.

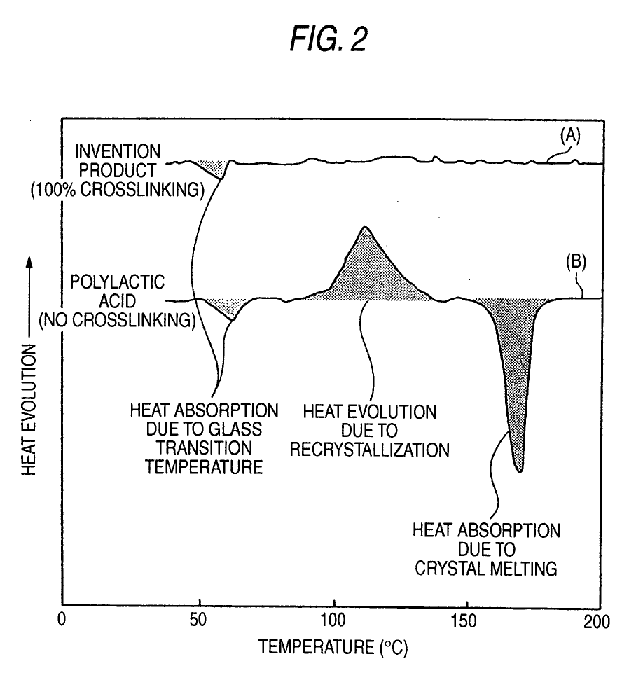

Namely, as shown by the line (A) in the graph of FIG. 2, in the case that the entire amount of polylactic acid is crosslinked, no heat evolution due to crystallization occurs even when it is heated to a temperature equal to or higher than the glass transition temperature of polylactic acid since no crystallization occurs, and also no heat absorption due to crystal melting at a temperature of the melting point or higher occurs.

On the other hand, in the case that polylactic acid is not crosslinked, as shown by the line (B), when temperature reaches the glass transition temperature, heat absorption once occurs and then heat evolution due to recrystallization occurs as temperature elevates. Furthermore, when temperature reaches a temperature of the melting point or higher, heat absorption due to the melting of crystals occurs.

Namely, the measured values in the melting point heat absorption analysis by means of a differential scanning calorimeter is a barometer for the maintenance of transparency at a high temperature. In the melting point heat absorption analysis by means of a differential scanning calorimeter, no heat absorption shows that no recrystallization occurs at a high temperature environment and transparency can be maintained.

The polylactic acid for use in the invention may be L-form, D-form or a mixture thereof, and they may be employed singly or as a mixture of two or more thereof.

As the monomer having two or more double bonds in its molecule to be mixed with polylactic acid, an acrylic or methacrylic monomer, e.g., 1,6-hexanediol diacrylate, trimethylolpropane trimethacryalte (hereinafter referred to as TMPT), or the like exhibits some effect but, in order to attain a high degree of crosslinking at a relatively low concentration, a monomer having an allyl group is effective.

Namely, polylactic acid, which has hitherto been considered to be radiodegradable and not to be crosslinked with a common monomer in a non-crystalline state, can be sufficiently crosslinked by radiation at non-crystalline parts using an ally monomer in only a small amount. Thus, by unifying the polylactic acid molecules through crosslinking almost the entire amount of them in a non-crystalline state, as mentioned above, the non-crystalline parts cannot freely move even when heated to a temperature equal to or higher than the glass transition temperature and hence decrease in transparency due to crystallization can be inhibited.

The monomer having an allyl group includes triallyl isocyanurate, trimethallyl isocyanurate, triallyl cyanurate, trimethallyl cyanurate, diallylamine, triallylamine, diacryl chlorendate, allyl acetate, allyl benzoate, allyl dipropyl isocyanurate, allyl octyl oxalate, allyl propyl phthalate, vinyl allyl maleate, diallyl adipate, diallyl carbonate, diallyldimethylammonium chloride, diallyl fumarate, diallyl isophthalate, diallyl malonate, diallyl oxalate, diallyl phthalate, diallyl propyl isocyanurate, diallyl sebacate, diallyl succinate, diallyl terephthalate, diallyl tartrate, dimethyl allylphthalate, ethyl allyl maleate, methyl allyl fumarate, methyl methallyl maleate, and the like.

In particular, preferred is triallyl isocyanurate (hereinafter referred to as TAIC), which exhibits a high effect on polylactic acid at a low concentration. Moreover, triallyl cyanurate, which is mutually transformable with TAIC by heating, also exhibits substantially the same effect.

The above monomer is preferably added in an amount of from 4% by weight to 8% by weight based on the weight of the polylactic acid. When the above monomer is mixed in an amount of 0.5% by weight or more, crosslinking is observed but it is not sufficient to crosslink the entire amount of polylactic acid to achieve a gel fraction of 100% for ensuring the maintenance of transparency at a high temperature. According to the experiments by the inventors, it is recognized that an amount of 4% by weight or more is necessary. Moreover, when the amount exceeds 8% by weight, it becomes difficult to mix the entire amount thereof homogeneously with polylactic acid and substantially a remarkable difference in the effects is not observed. Therefore, the monomer is desirably added in an amount of from 4% by weight to 8% by weight based on the weight of the polylactic acid as mentioned above. In particular, when the use as a biodegradable plastic is considered, it is desirable to use a larger amount of the polylactic acid which is sure to degrade and thus use of around 5% by weight of the monomer is most suitable when certainty of the effects is also considered.

Furthermore, as an additive to them, for the purpose of enhancing flexibility, a plasticizer that is liquid at ambient temperature, such as glycerin, ethylene glycol, or triacetylglycerin or a palsticizer that is solid at ambient temperature, such as polyglycolic acid or polyvinyl alcohol may be added, but the addition is not essential.

As mentioned above, the transparent polylactic acid material according to the invention is produced by molding a mixture obtained by homogeneously mixing the polylactic acid with the monomer having two or more double bonds in its molecule, preferably a monomer having an allyl group such as triallyl isocyanurate or triallyl cyanurate, under heating at a temperature of from the melting point of polylactic acid (about 160° C.) to 200° C., quenching the molded article to a temperature of about 60° C. or lower to maintain polylactic acid molecules in a non-crystalline state, and crosslinking and unifying almost the entire amount of the polylactic acid molecules in the non-crystalline state by irradiation with ionizing radiation in this state.

Specifically, the polylactic acid is first made be in a state where it is heated to a softening temperature or in a state where it is dissolved or dispersed in a soluble solvent such as chloroform or cresol.

Then, the above-described monomer is added thereto and they are homogeneously mixed as far as possible.

Thereafter, the mixture is again softened by heating or the like and molded into a desired shape. The molding may be carried out continuously after the softening by heating or in the solvent-dissolved state. Alternatively, the mixture may be once cooled or the solvent may be removed by drying and then the resulting mixture may be again softened by heating and molded into a desired shape through injection molding or the like.

In view of the object of the invention, it is important in the present invention to obtain a transparent molded article through thermal molding, in other words, to conduct cooling so as to reduce opaque crystalline parts and increase transparent non-crystalline parts. Crystallization from a heated and molten state proceeds more as the rate of the cooling is slower. Hence, slow cooling tends to induce crystallization. On the other hand, the degree of crystallization becomes smaller as the cooling is carried out more rapid, thus making the resulting product transparent.

With manufacturing speeds for industrial products that attach much value to productivity, polylactic acid is generally cooled below its glass transition temperature within several seconds to several dozen seconds. Therefore, such a general manufacturing speed makes the molded article sufficiently transparent.

Next, the molded article is crosslinked by irradiation with ionizing radiation. The exposure dose is preferably from 30 kGy to 150 kGy. The reason why the exposure dose is 30 kGy or more is that crosslinking is observed at an exposure dose of from 5 to 10 kGy depending on the monomer concentration but the crosslinking effect and the transparency-maintaining effect at a high temperature are observed at an exposure dose of 30 kGy or more. The exposure dose is more desirably 100 kGy or more, where the effects are certainly observed.

On the other hand, since polylactic acid per se has a property of being degraded with radiation, excessive irradiation may cause degradation contrary to crosslinking. Therefore, the upper limit of the exposure dose is desirably about 150 kGy.

Specifically, the entire amount of the polylactic acid molecules can be crosslinked to achieve a gel fraction of 100% when the exposure dose of ionizing radiation is 100 kGy or more in the case that the above-described monomer having an ally group is mixed in an amount of 4% by weight or when the exposure dose of ionizing radiation is 30 kGy or more in the case that the above-described monomer is mixed in an amount of 8% by weight.

As the ionizing radiation to be used, γ-ray, X-ray, β-ray, or α-ray may be employed but, for industrial production, a γ-ray irradiation with cobalt-60 or an electron beam by an electron beam accelerator is preferred.

Instead of the method of crosslinking by irradiation with ionizing radiation, crosslinking may be achieved using a chemical initiator. In that case, after polylactic acid is heated and melted at a temperature of the melting point or higher, the above-described monomer and a chemical initiator are added thereto, followed by thorough kneading. After homogeneously mixed, the mixture is molded and, after molding, the molded article is heated to a temperature where the chemical initiator is thermally decomposed.

The chemical initiator usable in the invention may be any of peroxide catalysts or catalysts capable of initiating polymerization of monomers, such as dicumyl peroxide, peroxypropionitrile, benzoyl peroxide, di-t-butyl peroxide, diacyl peroxide, pelargonyl peroxide, myristoyl peroxide, t-butyl perbenzoate, or 2,2′-azobisisobutyronitrile. Crosslinking is preferably conducted under an inert atmosphere from which air is removed or under vacuum as in the case of irradiation with radiation.

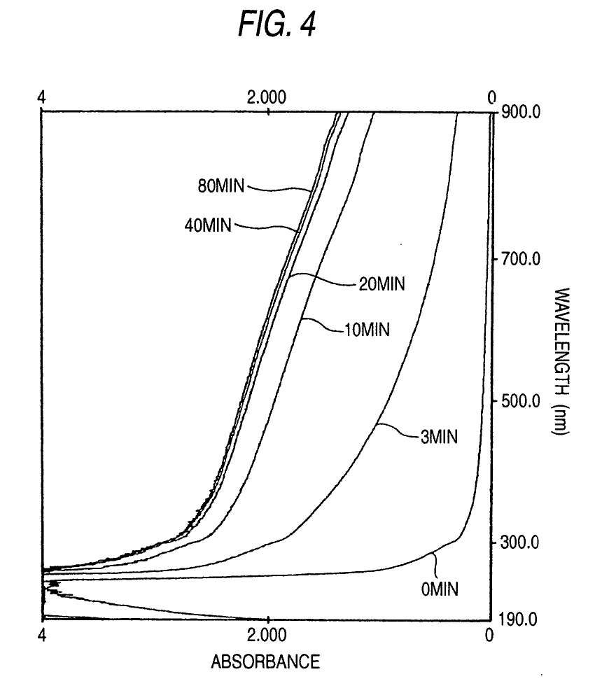

In addition, it is also possible to effect crosslinking by irradiation with ultraviolet ray. However, since polylactic acid absorbs ultraviolet ray as shown below in FIGS. 4 to 6, a similar crosslinking effect can be expected even by irradiation with ultraviolet ray in the case that a product is an extremely thin film but it is difficult to crosslink the entire product in the case that the product is thick. Therefore, ionizing radiation is superior to ultraviolet ray for use in the present invention.

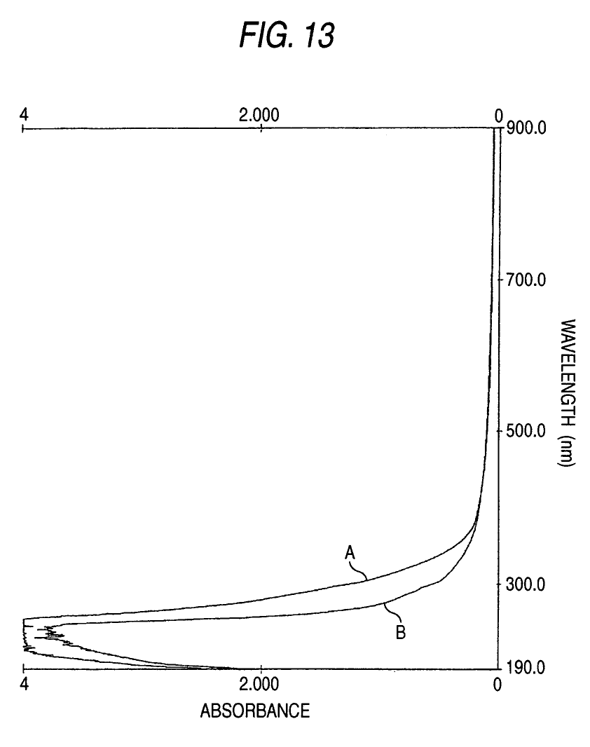

There may be the case where the molded article contains an unreacted residue of TAIC because of the use of an excessive amount of TAIC for fully crosslinking polylactic acid. In such a case, the molded article after irradiation may become to have a pale brown color by activation of the unreacted residue of TAIC through the irradiation. Although the pale brown color gradually disappears with time, it can be accelerated by conducting an annealing treatment after the irradiation. The annealing treatment inactivates the activated, unreacted residue of TAIC, thereby the molded article after irradiation is made transparent. Although an annealing time of 5 minutes exhibits some effect, it is preferred to conduct the annealing treatment for at least 1 hour. FIG. 13 shows an example of the absorbance characteristic of an annealed (100° C., 1 hour) product (B) relative to that of a corresponding non-annealed product (A) which is a 50-kGy irradiated product.

As mentioned above, since the transparent material made of polylactic acid according to the invention is obtained by crosslinking the entire amount of polylactic acid molecules in a non-crystalline state where the molecules take a random arrangement, the polylactic acid molecules are unified by crosslinking and cannot freely move to effect crystallization even when they are placed under a high-temperature environment of 60° C. (i.e., the glass transition temperature) or higher. Therefore, the disadvantage of polylactic acid that it gradually loses transparency and is whitened can be remarkably improved and thus transparency can be maintained.

Moreover, the transparent material made of polylactic acid has an extremely small influence on ecosystem in nature because of its biodegradability, so that the material can be suitably used as a substitute material for entire plastic products produced and discarded in a large scale.

### EXAMPLES

The present invention will be illustrated in greater detail with reference to the following Examples and Comparative Examples, but the invention should not be construed as being limited thereto.

### Example 1

As polylactic acid, pellet polylactic acid LACEA H-400 manufactured by Mitsui Chemicals, Inc. was used. The polylactic acid was melted at 180° C. and thoroughly kneaded to be transparent in an almost closed kneader, Laboplastomill. TAIC, which is an allyl monomer, was added thereto in an amount of 4% by weight based on the weight of the polylactic acid, followed by thorough kneading and mixing at a rotation number of 40 rpm for 5 minutes. Thereafter, the kneaded product taken out of the kneader is hot-pressed at 180° C. and then quenched with water to prepare a sheet having a thickness of 500 μm.

The sheet was irradiated with an electron beam in an amount of 100 kGy or 150 kGy by means of an electron beam accelerator (acceleration voltage of 2 MeV, current of 1 mA) under an inert atmosphere from which air was removed.

The radiation-crosslinked products obtained by the above method were referred to as Example 1.

### Examples 2 and 3

The same operations as in Example 1 were conducted except that the concentration of TAIC was changed to 5% by weight, and the products were referred to as Example 2. Further, the same operations as in Example 1 were conducted except that the concentration of TAIC was changed to 8% by weight and the exposure dose of the electron beam was changed to 30 kGy, 50 kGy, 100 kGy or 150 kGy, and the products were referred to as Example 3.

### Comparative Examples 1 to 6

The same operations as in Example 1 or 2 were conducted except that the exposure dose of the electron beam was changed to 0 kGy, 10 kGy, 30 kGy or 50 kGy, and the products were referred to as Comparative Example 1 or 2, respectively.

The same operations as in Example 3 were conducted except that the exposure dose of the electron beam was changed to 0 kGy or 10 kGy, and the products were referred to as Comparative Example 3.

The same operations as in Example 1 were conducted except that TAIC was not mixed and the exposure dose of the electron beam was changed to 0 kGy, 10 kGy, 30 kGy, 50 kGy, 100 kGy or 150 kGy, and the products were referred to as Comparative Example 4.

The same operations as in Example 1 were conducted except that the concentration of TAIC was changed to 2% by weight or 3% by weight and the exposure dose of the electron beam was changed to 0 kGy, 10 kGy, 30 kGy, 50 kGy, 100 kGy or 150 kGy, and the products were referred to as Comparative Example 5 or 6, respectively.

The following Table 1 summarizes the differences of production conditions in the above Examples 1 to 3 and Comparative Examples 1 to 6.

TABLE 1

| TAIC | Exposure dose of electron beam | | |
|---|---|---|---|
| concentration | 0, 10 kGy | 30, 50 kGy | 100, 150 kGy |

| | | |
|---|---|---|
| 4% | Comparative Example 1 | Example 1 |
| 5% | Comparative Example 2 | Example 2 |

| | | |
|---|---|---|
| 8% | Comparative | Example 3 |
| | Example 3 | |

| | |
|---|---|
| 0% | Comparative Example 4 |
| 2% | Comparative Example 5 |
| 3% | Comparative Example 6 |

TAIC Exposure dose of electron beam concentration 0, 10 kGy 30, 50 kGy 100, 150 kGy 4% Comparative Example 1 Example 1 5% Comparative Example 2 Example 2 8% Comparative Example 3 Example 3 0% Comparative Example 4 2% Comparative Example 5 3% Comparative Example 6

Evaluation of Examples and Comparative Examples

On each of Examples and Comparative Examples, the following evaluation of gel fraction (1) and evaluation of transparency maintenance at high temperature (2) to (4) were carried out.

(1) Evaluation of Gel Fraction:

As mentioned above, 0.5 g of each sheet was wrapped in a 200 mesh stainless woven wire and boiled in chloroform for 48 hours, and then remaining gel matter was obtained by removing sol matter dissolved in chloroform. Chloroform in the gel matter was removed by drying at 50° C. for 24 hours and dry weight of the gel matter was measured, followed by calculation of a gel fraction according to the following equation.
(Gel fraction (%))=(dry weight of gel matter)/(initial dry weight)×100

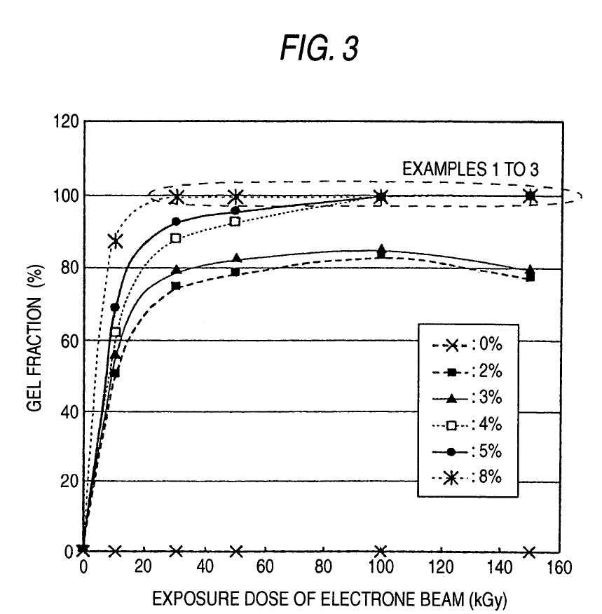

The gel fractions obtained by the above method are shown in FIG. 3. FIG. 3 shows relation between the exposure dose of electron beam and the gel fraction at each monomer concentration in each of the Examples and Comparative Examples.

As shown in FIG. 3, in Comparative Examples 5 and 6 where the TAIC concentration was less than 4% by weight, the gel fraction increased only to about 80% even when the electron beam was applied in an increased amount.

From the results of Comparative Examples 1 to 3, even when the TAIC concentration was 4% by weight or more, the gel fraction was found to be insufficient in the case that the exposure dose of radiation was about several tens kGy. It was also found that, even when the concentration was 8% by weight that was considered to be a saturated concentration of TAIC in polylactic acid, the gel fraction did not reach 100% in the case that the exposure dose of radiation was 10 kGy.

In Examples 1 to 3, when the TAIC concentration was 4 or 5% by weight, the gel fraction reached about 100% with the exposure dose of radiation of 100 kGy or more, and when the concentration was 8% by weight, the gel fraction reached about 100% with the exposure dose of radiation of 30 kGy or more. Furthermore, when the exposure dose of radiation went beyond 150 kGy, the gel fraction gradually decreased.

In Comparative Examples 5 and 6, when the exposure dose of radiation was 150 kGy, it was found that the gel fraction decreased as compared with the case of 100 kGy. This result indicates that crosslinking by irradiation with the electron beam has completed and the effect of the irradiation has turned to the direction of degradation of the polylactic acid at around 100 kGy.

In the Examples, even when the exposure dose of radiation was 150 kGy, the gel fraction was still 100% but it was considered that the degradation was similarly initiated and thus a tendency that the samples were readily cracked was observed.

(2) Evaluation of Transparency Maintenance at High Temperature 1:

A sample was molded into a rectangle having a width of 1 cm and a length of 10 cm and then was allowed to stand in a constant-temperature bath at 100° C. for a definite period of time. Thereafter, it was quenched to room temperature and the absorbance thereof in the wavelength range of from 190 nm to 900 nm corresponding to ultraviolet light to visible light was measured on a spectrophotometer UV-265FW manufactured by Shimadzu Corporation.

FIGS. 4 to 6 show the results of three examples: Comparative Example 4 where polylactic acid is used alone with no TAIC (the exposure dose of radiation of 0 kGy), Comparative Example 5 where the TAIC concentration is 2% by weight (the exposure dose of radiation of 50 kGy, the gel fraction of about 80%), and Example 1 where the TAIC concentration is 4% by weight (the exposure dose of radiation of 100 kGy, the gel fraction of 100%).

First, in Comparative Example 4 of polylactic acid alone containing no TAIC shown in FIG. 4, it was found that mere exposure of the sample at a temperature of 100° C. for 3 minutes caused decrease of transmittance of visible light to about 1/10 (absorbance=1). Thereafter, when the sample was still placed in the constant-temperature bath at 100° C., it was found that the sample of Comparative Example 4 was rapidly whitened and the transmittance of visible light became 1/100 (absorbance=2). It was recognized from the figure that this change was saturated at about 80 minutes.

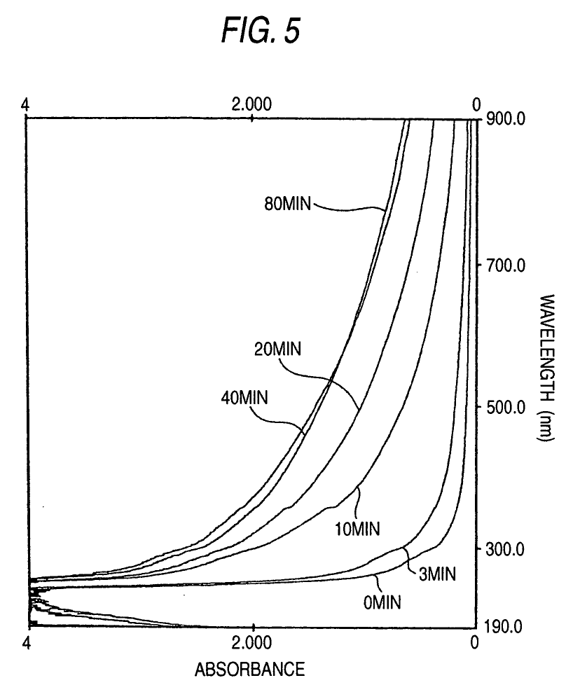

In Comparative Example 5 where the TAIC concentration was 2% by weight (the exposure dose of radiation of 50 kGy, the gel fraction of about 80%) shown in FIG. 5, it was found that both of the rate of whitening and the saturation value were diminished but the transmittance of visible light was decreased to almost several percent of its original value. Therefore, it was found that there was observed substantially no effect on the maintenance of transparency.

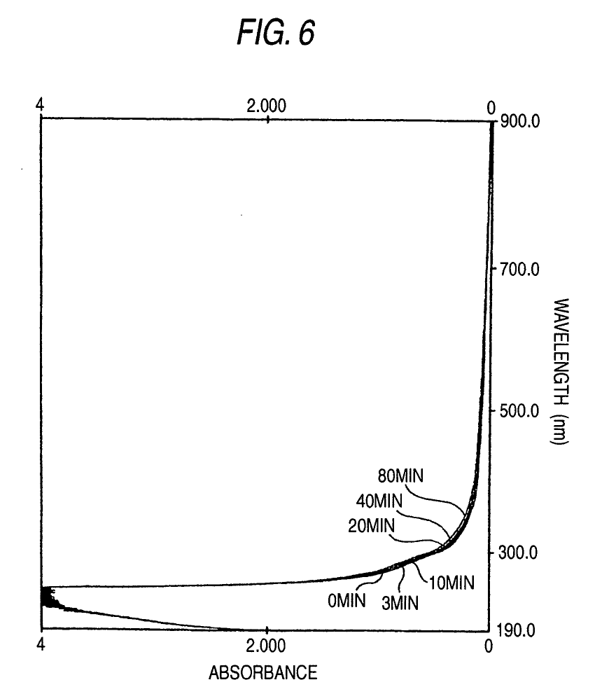

Contrary to these results, in Example 1 where the TAIC concentration was 4% by weight and the gel fraction was 100% (the exposure dose of radiation of 100 kGy) shown in FIG. 6, no change in absorbance was observed over the period of 80 minutes and thus transparency was maintained. The same results were observed in the other Examples 2 and 3. Contrarily, in Comparative Examples other than the above Comparative Examples 4 and 5, whitening was observed even visually in all cases although there were some differences depending on the gel fraction.

(3) Evaluation of Transparency Maintenance at High Temperature 2:

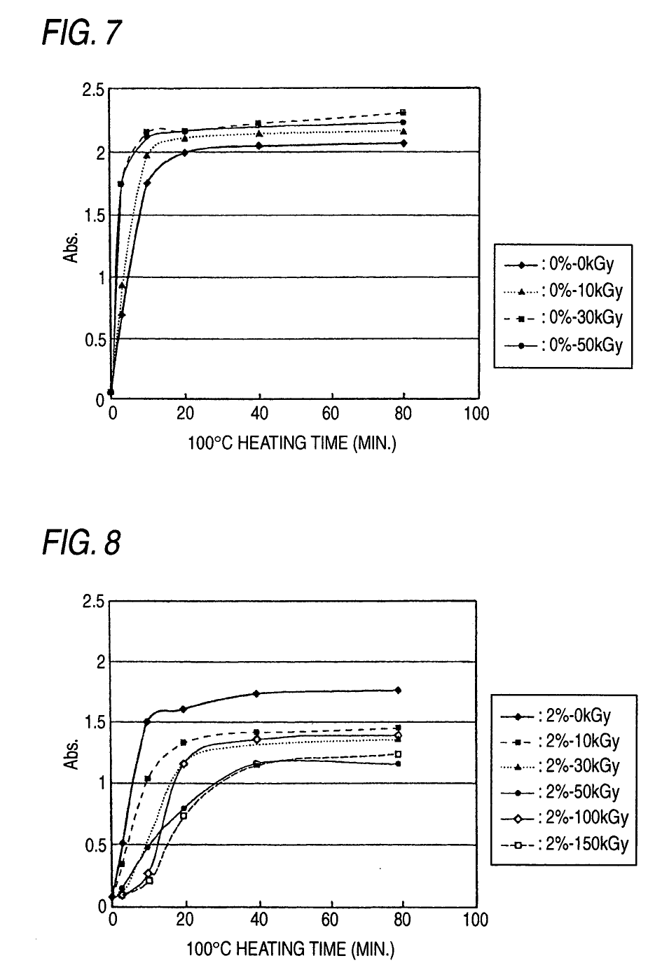

A change of the absorbance with time was measured in the same manner as in the (2) Evaluation of transparency maintenance at high temperature 1 except that the absorbance was measured with fixing the wavelength at 600 nm. The results are shown in FIGS. 7 to 11.

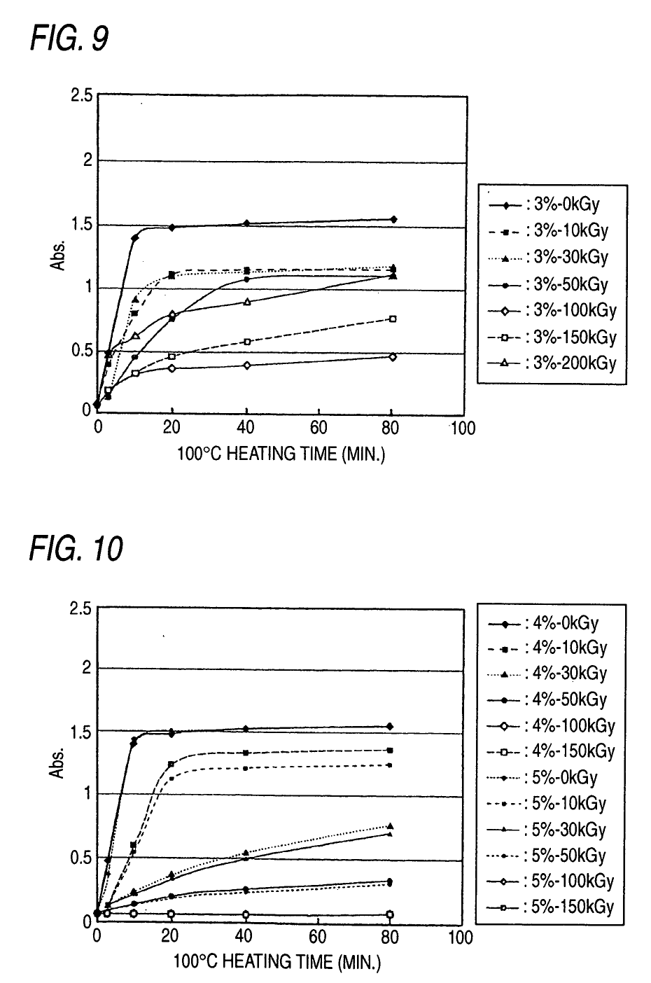

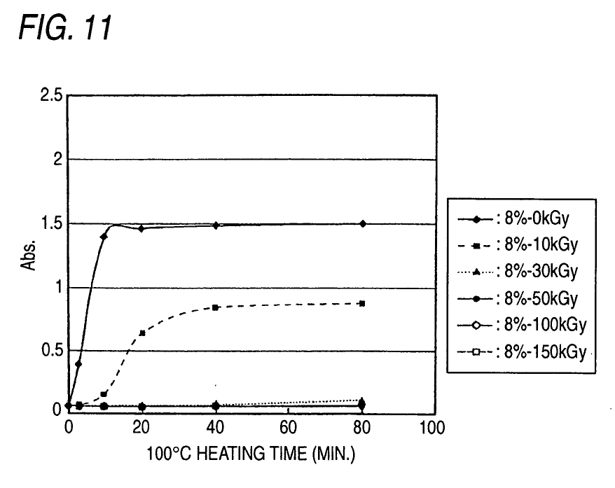

FIG. 7 shows the results of Comparative Example 4 containing no TAIC, FIG. 8 shows the results of Comparative Example 5 where the TAIC concentration is 2% by weight, FIG. 9 shows the results of Comparative Example 6 where the TAIC concentration is 3% by weight, FIG. 10 shows the results of Example 1 and Comparative Example 1 where the TAIC concentration is 4% by weight and Example 2 and Comparative Example 2 where the TAIC concentration is 5% by weight, and FIG. 11 shows the results of Example 3 and Comparative Example 3 where the TAIC concentration is 8% by weight.

First, in Comparative Example 4 of polylactic acid alone containing no TAIC shown in FIG. 7, the transmittance of light was decreased to 1% or less of its original value after 20 minutes in the constant-temperature bath at 100° C.

In Comparative Example 5 where the TAIC concentration was 2% by weight shown in FIG. 8, an inhibitory effect on whitening was observed but the transmittance of light was decreased to 10% or less of its original values in all cases.

In Comparative Example 6 where the TAIC concentration was 3% by weight shown in FIG. 9, an inhibitory effect on whitening, i.e., the transmittance of up to about 30%, was observed when the exposure dose of radiation was 150 kGy but the effect contrarily became worse when the exposure dose of radiation was 200 kGy.

Contrary to these results, when the TAIC concentration was 4% by weight or 5% by weight shown in FIG. 10, the transmittance of light could be maintained at a level of several tens percent of its original values when the exposure dose of the electron beam was 30 or 50 kGy and no change in absorbance was confirmed in Examples 1 or 2 where the exposure dose of the electron beam was 100 or 150 kGy.

Furthermore, also in Example 3 where the TAIC concentration was 8% by weight, it was confirmed that inhibition of decrease in the transmittance of light, i.e., the maintenance of transparency was possible even when the exposure dose of the electron beam was 30 kGy.

(4) Evaluation of Transparency Maintenance at High Temperature 3:

A heat absorption curve of each of Examples and Comparative Examples was measured on a differential scanning calorimeter.

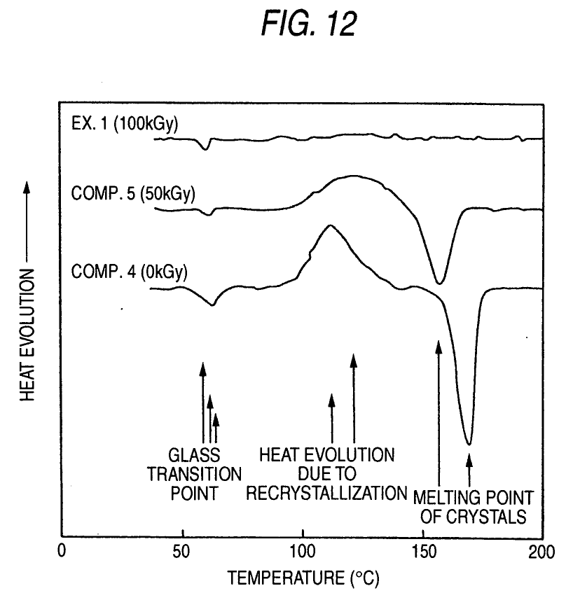

The measurement was carried out for three examples shown in FIGS. 4 to 6. The results are shown in FIG. 12.

In Comparative Example 4 where no crosslinking was conducted, as shown in FIG. 12, there were observed an absorption peak based on the glass transition point at around 60° C., a heat absorption peak based on the melting point at around 160° C., and heat evolution due to recrystallization between both peaks. Contrary to the results, in Comparative Example 5 where the gel fraction was about 80%, the calorie of each of the heat evolution and heat absorption decreased as compared with that in the case of Comparative Example 4.

To the contrary, both the heat evolution peak due to recrystallization and the heat absorption peak due to crystal melting disappeared in Example 1 as shown in FIG. 12. This fact indicates that in Example 1 where the gel fraction is 100%, the polylactic acid molecules are crosslinked in such a state that they cannot freely move to effect recrystallization even when heated to a temperature of its glass transition point or higher.

The transparent material made of polylactic acid according to the invention is applicable to a wide range of fields where transparency of plastics is utilized, including agricultural films, lighting windows for greenhouse, electric appliances such as mobile phones and liquid crystal panels, window materials for automobile meters, content-viewable packaging materials, and the like. In addition, owing to no influence on living body, the material is also a suitable material for application to medical equipments such as injection syringes and catheters to be utilized in vivo or in vitro.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2004-123461 and the contents thereof are herein incorporated by reference.

1. A process for producing a transparent polylactic acid material, comprising the steps of:
kneading a polylactic acid with a monomer having two or more double bonds in its molecule;
molding the kneaded product at a temperature of from the melting point of the polylactic acid to 200° C. to obtain a molded article;
quenching the molded article after molding; and
subjecting the quenched molded article to crosslinking treatment so as to prevent molecules of the polylactic acid from undergoing recrystallization.

2. The process according to claim 1, wherein the crosslinking treatment is conducted by irradiation with ionizing radiation or through preliminary incorporation of a chemical initiator into the kneaded product.

3. The process according to claim 2, wherein the ionizing radiation is conducted in an exposure dose of from 30 kGy to 150 kGy.

4. A transparent polylactic acid material obtained by the process for producing a transparent polylactic acid material according to any one of claims 1 to 3.

5. A transparent polylactic acid material, formed from a mixture comprising a polylactic acid and a monomer having two or more double bonds in its molecule, wherein molecules of the polylactic acid are crosslinked and unified in a non-crystalline state where the polylactic acid molecules take a random arrangement, so that the polylactic acid molecules keep the non-crystalline state and are not recrystallized even when they are heated at a temperature equal to or higher than the glass transition temperature thereof.

6. The transparent polylactic acid material according to claim 4 or 5, which exhibits no heat absorption due to crystal melting at the melting temperature of the polylactic acid in a melting point heat absorption analysis by means of a differential scanning calorimeter.

7. The transparent polylactic acid material according to any one of claims 4 to 6, wherein the entire amount of the polylactic acid is crosslinked and the transparent polylactic acid material has a gel fraction (dry weight of gel matter/initial dry weight) of 100%.

8. The transparent material made of polylactic acid according to any one of claims 4 to 7, wherein the monomer has an allyl group.

9. The transparent material made of polylactic acid according to claim 8, wherein the mixture contains the monomer having an allyl group in an amount of from 4% by weight to 8% by weight based on the weight of the polylactic acid.

10. The transparent material made of polylactic acid according to claim 8 or 9, wherein the monomer having an allyl group is triallyl isocyanurate or triallyl cyanurate.
